(19) United States
(12) Patent Application Publication
(10) Pub. No.: US 2004/0162851 A1
(43) Pub. Date: Aug. 19, 2004

(54) Method and apparatus linking diagnostic and configuration information with service information

(76) Inventor: Da-Nhat Nguyen, Campbell, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/370,162

(22) Filed: Feb. 18, 2003

(51) Int. Cl. G06F 7/00

(52) U.S. Cl. 707/104.1

(57) ABSTRACT

A method of servicing electronic equipment includes receiving a service code wirelessly broadcast from the electronic equipment to a service apparatus. The code may be in the form of a uniform resource identifier to facilitate identifying a database. The database is accessed to retrieve information associated with the code. Access to the database may be limited by user authorization defined by a user key. The retrieved information is communicated to at least one of the electronic equipment or a display of the service apparatus. The retrieved information may include any combination of service instructions, configuration parameters, or firmware for the electronic equipment. In one embodiment, a visual service indicator flashes with a first flash sequence in response to a service code event of the electronic equipment and then with a second flash sequence in response to a wireless communication from the service apparatus.

### FIELD OF THE INVENTION

This invention relates to the field of servicing equipment. In particular, this invention is drawn to obtaining diagnostic and configuration information as well as servicing electronic equipment.

### BACKGROUND OF THE INVENTION

Manufacturers provide a number of tools to aid service technicians or users configure, diagnose, repair, and update electronic products. Frequently, diagnostic or configuration information is indicated using a display panel such as a liquid crystal display (LCD). Laser printers and facsimile machines, for example, typically display configuration information, diagnostic error messages, and service instructions on an LCD panel. Some machines (e.g., photocopiers) often use a display to graphically illustrate a course of action accompanied by service instructions.

One disadvantage of such displays is that they are relatively expensive to implement. The displays are also limited in the amount of information that can be displayed. Error messages are often cryptic in order to accommodate the display limitations. Detailed diagnostic or service information must frequently be obtained from an alternative source such as a reference manual.

Yet another disadvantage is that there is no standard for graphics or text messages in these equipment displays. Each display is proprietary and requires a unique process for implementation and update.

### SUMMARY OF THE INVENTION

In view of limitations of known systems and methods, various methods for servicing electronic equipment using wireless communications are described.

A method of servicing electronic equipment includes receiving a service code wirelessly broadcast from the electronic equipment to a service apparatus. The code may be in the form of a uniform resource identifier to facilitate identifying a database. The database is accessed to retrieve information associated with the code. Access to the database may be limited by user authorization defined by a user key. The retrieved information is communicated to at least one of the electronic equipment or a display of the service apparatus. The retrieved information may include any combination of service instructions, configuration parameters, or firmware for the electronic equipment.

In one embodiment, a visual service indicator flashes with a first flash sequence in response to a service code event of the electronic equipment and then with a second flash sequence in response to a wireless communication from the service apparatus.

One embodiment of service apparatus includes a local nonvolatile memory that stores a database containing at least one of the following types of information: service instructions, configuration parameters, and firmware for the electronic apparatus. The service apparatus includes a display and a wireless communication port. Information associated with a received service code wirelessly broadcast from the electronic equipment is retrieved from the database. The retrieved information is communicated to at least one of the display and the electronic equipment.

In various embodiments, the wireless communication may take place at radio or optical frequencies. Communication between the electronic equipment may be uni-directional or bi-directional. Bi-directional communication may use either linkless or linked communication protocols. The service code provided by the electronic equipment may be in the form of a uniform resource identifier (URI) to facilitate identifying the location of the database.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of an apparatus for servicing electronic equipment.

FIG. 2 illustrates one embodiment of a method of servicing electronic equipment.

FIG. 3 illustrates another embodiment of a method of servicing equipment.

FIG. 4 illustrates one embodiment of a method of servicing equipment using bi-directional wireless communication.

FIG. 5 illustrates one embodiment of a method of indicating the electronic equipment with which the service apparatus is communicating.

### DETAILED DESCRIPTION

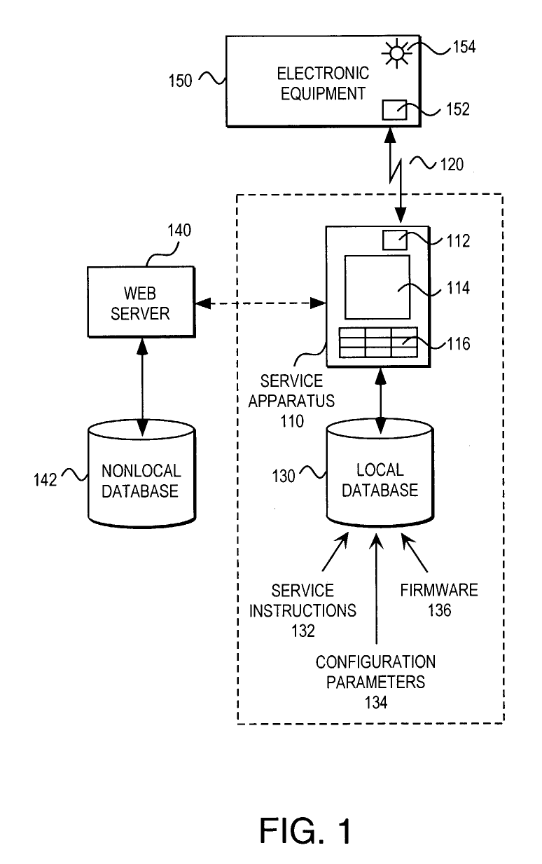

FIG. 1 illustrates a service apparatus 110 for servicing electronic equipment 150. In one embodiment, the electronic equipment includes an indicator 154 that notifies the user that that attention is required. For example, a light emitting diode (LED) that emits light in the visible light portion of the electromagnetic spectrum may be used to signal that the electronic equipment needs attention.

Service apparatus 110 is positioned within the communication range of electronic equipment 150 to enable wireless communication 120 between an electronic equipment wireless communications port 152 and a wireless communications port 112 of the service apparatus. The electronic equipment communications port 152 includes a transmitter. The service apparatus communications port 112 includes a receiver. Service information is wirelessly communicated to the service apparatus 110 via the communication ports.

Service information transmitted by electronic equipment 150 may include configuration or service codes. Configuration codes describe the model and the values of configurable parameters. Baud rate, contrast, number of rings before answer, volume, etc. are examples of the types of information that may be indicated by configuration codes. Service codes are typically used to indicate a fault condition or a maintenance request. Paper jams, low toner, out of paper, etc. would be indicated by service codes.

The wireless communications may operate at radio frequencies (i.e., any frequency within the electromagnetic spectrum normally associated with radio wave propagation). Radio frequencies are arbitrarily defined as frequencies less than 3000 GHz.

In some embodiments, the wireless communication operates at optical frequencies. Optical frequencies range from approximately 3000 GHz and include the ultraviolet, visible, and infrared portions of the electromagnetic spectrum. Thus, for example, infrared LEDs may be used to implement infrared communications.

The communication between the electronic equipment and the service apparatus may be based on a linking or a linkless communication protocol. The process of establishing a communication link between the devices involves a handshaking or negotiation stage and the devices are then aware of each other's presence. In a linkless environment, the devices are not aware of each other. Although the devices may respond to any received communications, the devices broadcast their communication independently of the presence of another device and without handshaking or negotiation between the devices.

Service apparatus 110 receives configuration or service codes from electronic equipment 150 via wireless communications 120. Service apparatus 110 then accesses an associated local database 130 to retrieve more detailed information associated with the codes.

The retrieved information may include a decoded value for the code or detailed instructions for addressing the condition that caused the code to be generated, for example. The database includes service instructions 132, configuration parameters 134, firmware 136, or some combination of these.

In one embodiment, service instructions 134 include text and graphics and are stored in extensible markup language (XML) format to facilitate presentation on the service apparatus display 114. Service apparatus 110 includes command and control keys 116 to permit entering commands and scrolling the displayed text and graphics including any retrieved information.

In one embodiment, local database 130 is implemented in nonvolatile memory residing within service apparatus 110. In an alternative embodiment, at least some of the information to be retrieved is not available within database 130. In such a case, service apparatus 110 establishes a connection with an external web server 140 and nonlocal database 142 to retrieve information associated with the code.

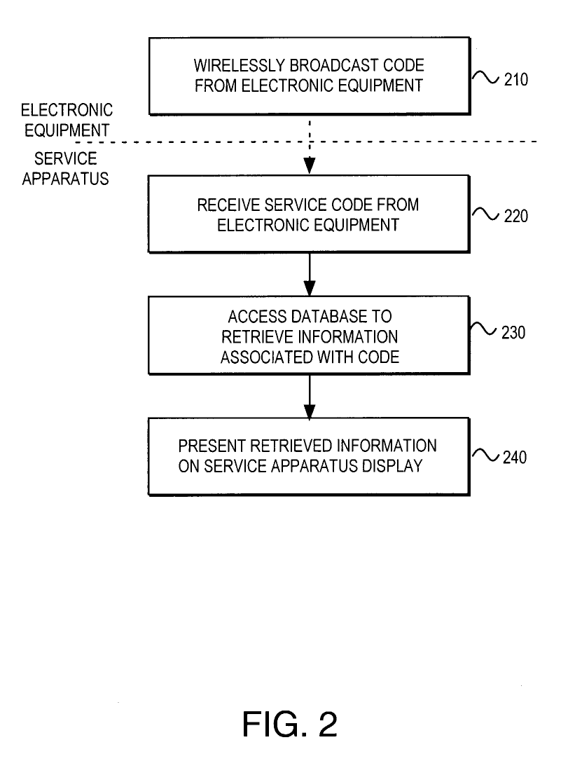

FIG. 2 illustrates a method of servicing electronic equipment using the service apparatus of FIG. 1. In step 210, the electronic equipment wirelessly broadcasts at least one service code. The broadcast is not directed to any specific device. The service code is broadcast independently of the presence of any service apparatus or established communication link between the service apparatus and electronic equipment.

The service apparatus receives at least one code from the electronic equipment in step 220. The service apparatus accesses a database to retrieve service information associated with the service code in step 230. The service information is displayed on a service apparatus display in step 240. The displayed service information, for example, might include excerpts from a service manual that are related to the broadcast service code. Command and control keys of the service apparatus may be used to scroll through the service information.

Although service information provided by a local database may be appropriate for a typical consumer or user of the electronic equipment, more detailed information may be available from an external database. In such a case, step 230 may require communicating with a remote web server to access a database external to the service apparatus as indicated in FIG. 1.

An external database may be preferable given the inherent storage limitations of a local database. An external database may also facilitate a controlled access service model to limit dissemination of detailed service instructions and schematics to authorized service technicians.

The displays located on individual units of electronic equipment are specific to the individual units of equipment. A single service apparatus, however, may be used to service more than one unit of electronic equipment. In particular, a single service apparatus may be used to service multiple units of the same or different type.

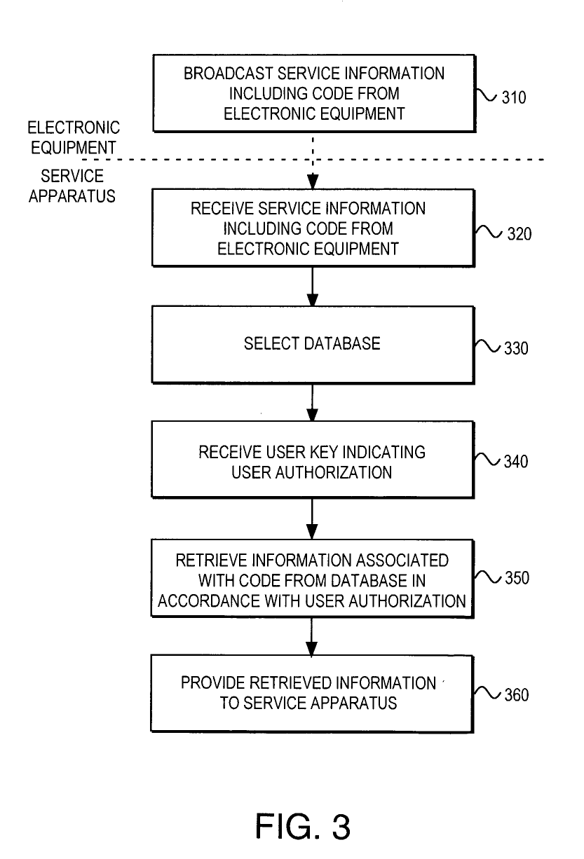

FIG. 3 illustrates a method of servicing electronic equipment that may be more suitable for supporting a variety of types of electronic equipment. Storing extensive service information for a variety of models on a local database may be impractical.

In step 310, service information including a service code is broadcast from the electronic equipment. The service apparatus receives the service information including a code from the electronic equipment in step 320. In step 330, the service apparatus selects a database. As indicated in FIG. 1, the database may be either local or non-local to the service apparatus. The service information received from the electronic equipment may include a uniform resource identifier (URI) that identifies the database to be selected.

A user key is received in step 340. The user key is indicative of user authorization. By providing different levels of user authorization a manufacturer may control access to the service information. Consumers, for example, may be permitted to access basic information such as the text description of the service code and typical courses of action to remedy the condition causing the code. Manufacturer authorized service technicians may be provided with greater detail of information particularly for service codes relating to conditions that might require access to the interior of the electronic equipment.

Information associated with the service code is retrieved from the database in accordance with the user's authorization in step 350. The retrieved information may be a static web page such as an excerpt from a manual. The retrieved information may be a non-web page resource such as a binary file. The retrieved information may alternatively be dynamically generated in response to the uniform resource identifier (e.g., active server pages rather than static web pages). The retrieved information is provided to the service apparatus in step 360.

Uni-directional communication between the electronic equipment and the service apparatus does not provide for extensive testing or any updating of the electronic equipment. The electronic equipment can only broadcast information in a pre-determined manner.

Bi-directional communication enables support for remote configuration or firmware updates as well as more advanced diagnostic capabilities. Referring to FIG. 1, communication ports 112 and 152 may be designed as transceivers capable of both receiving and transmitting with each other to enable bi-directional communication 120. Bi-directional communication enables updating configuration parameters and firmware by communicating configuration parameters 134 and firmware 136 to the electronic equipment. The electronic equipment can respond to commands issued from the service apparatus to perform additional diagnostic steps.

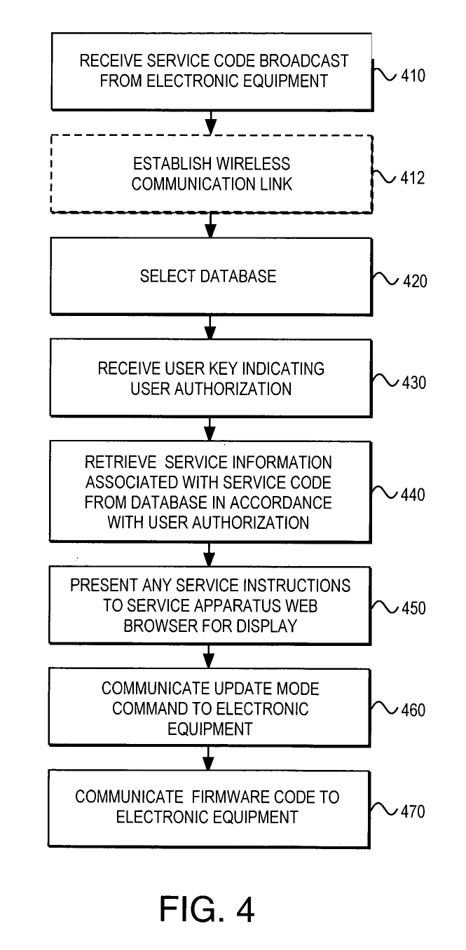

FIG. 4 illustrates one example of a process of servicing electronic equipment with wireless bi-directional communication. In step 410, the service apparatus receives a service code broadcast by the electronic equipment. At least the initial broadcast is independent of the presence of the service apparatus or any communication link. The electronic equipment may send subsequent service codes in response to queries communicated by the service apparatus. For example, the service apparatus might request make, model, serial number, configuration codes, or error codes from the electronic equipment. Communication after the broadcast of the initial service code may take place using either a link-less or a linked communication protocol. Thus the illustrated process includes the optional step 412 of establishing a wireless communication link.

In step 420, a database is selected for retrieving service information. The database may be local or non-local to the service apparatus. The service code received in step 410 may inherently identify the database or the location of the database to be selected.

A user key is received in step 430. The user key distinguishes different levels of authorization for access to the database. An authorized service representative, for example, may have a key that permits access to the database without restrictions on scope of access. A consumer level user key, however, may restrict the user to obtaining only user manuals for the electronic equipment.

The service apparatus retrieves service information associated with the code in accordance with the user's authorization in step 440. The information may be retrieved locally from the service apparatus or from a geographically remote server or some combination of these sources. In one embodiment, the information is retrieved from a database using the code.

In one embodiment, the service code includes a uniform resource identifier URI that specifies at least a portion of a pathname for the location of the database. The database may contain service instructions, configuration parameters, or firmware updates suitable for updating the firmware of the electronic equipment.

Retrieved service instructions may be presented on the display of the service apparatus in step 450. The service apparatus may include a web browser for controlled (e.g., paging, scrolling, etc.) presentation of the service instructions.

The bi-direction wireless communication enables updating configuration parameters or firmware from the service apparatus. Generally, the contents of the nonvolatile memory storing the firmware cannot simply be replaced with an update. The electronic equipment must have an “update mode” to replace its firmware. The “update mode” prohibits communication between the electronic equipment and other devices in order to update a nonvolatile memory with the received firmware update in a reliable, secure manner. Thus the “update mode” command is wirelessly communicated to the electronic equipment in step 460.

Firmware (e.g., binary files, executable code) updates are communicated to the electronic equipment via the bi-directional communication link in step 470. The electronic equipment updates its firmware in accordance with its “update mode” process upon receipt of the firmware update.

Configuration parameters may be communicated to the electronic equipment or displayed on the service apparatus display. Thus for example, values for programmable thresholds may be displayed to permit the user to manually program them into the electronic equipment. Alternatively, one or more of the values may be wirelessly communicated to the electronic equipment via the communication ports to set a selected configuration parameter value.

In some environments it may be difficult to pinpoint the location of the electronic equipment that the service apparatus is communicating with. For example, numerous devices in close proximity may complicate identifying the equipment that needs servicing. This can be remedied in some situations by providing a visual indicator such as indicator 154 illustrated in FIG. 1 whenever a condition arises that would require broadcasting service codes.

Indication of a service code condition may not uniquely identify the equipment if more than one piece of equipment is experiencing a service code event. In one embodiment, the service information broadcast by the electronic equipment includes a location code programmed into the equipment by the user. The location code might indicate rack number, shelf number, and drive number in a storage array environment, for example.

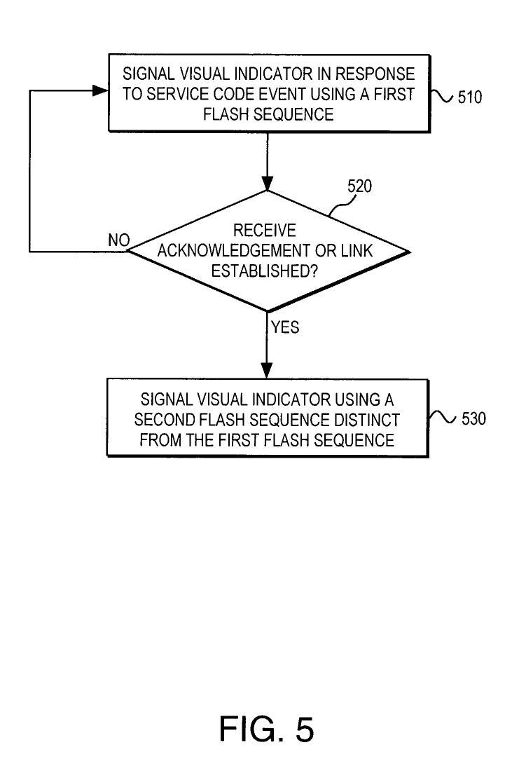

FIG. 5 illustrates a service code event indicator process that aids in visually identifying the electronic equipment with which the service apparatus is communicating for bi-directional communication environments. In step 510, a visual service code indicator is signaled in response to a service code event. This may result in a flashing, visible light, for example that uses a first flash sequence. The flash sequence is defined by color and a waveform describing the light intensity as a function of time. The first flash sequence may be dependent upon the service code.

In a bi-directional environment, the service apparatus can send an acknowledgement to the electronic equipment or alternatively establish a wireless communication link. In order to provide visual indication of communication, the visible indicator 154 uses a second flash sequence in response to an acknowledgement or the establishment of the wireless communication link. The second flash sequence is distinct from the first flash sequence. The flash sequences may be distinguished by color or waveform patterns. For example, the first flash sequence may consist of a red light flashing at a first interval. The second flash sequence might be a constant yellow light or a red light flashing at a second interval distinct from the first.

Bi-directional wireless communication thus enables modifying configuration parameters or firmware code wirelessly using the service apparatus. The use of browser and web page technology eliminates the need for carrying around bulky manuals that cannot be easily updated. Moreover, the use of multiple levels of authorization supports providing different levels of detail to various classes of users such as consumers, service technicians, and authorized service technicians.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of servicing electronic equipment, comprising:
a) receiving a code wirelessly broadcast from the electronic equipment;
b) accessing a database to retrieve information associated with the code; and
c) presenting the retrieved information on a display of a service apparatus.

2. The method of claim 1 wherein the database is local to the service apparatus.

3. The method of claim 1 wherein the database is not local to the service apparatus.

4. The method of claim 1 wherein the code is in the form of a uniform resource identifier.

5. The method of claim 1 wherein step b) further comprises accessing a web server.

6. The method of claim 1 wherein step b) further comprises restricting the retrieval of information in accordance with a user authorization indicated by a user key.

7. The method of claim 1 wherein the communication is uni-directional.

8. The method of claim 1 wherein the communication between the service apparatus and electronic equipment uses optical frequencies.

9. The method of claim 1 wherein the retrieved information includes at least one of the following types of information: service instructions, and configuration parameters for the electronic apparatus.

10. A method of servicing electronic equipment, comprising:
a) receiving a code wirelessly broadcast from the electronic equipment to a service apparatus;
b) accessing a database to retrieve information associated with the code; and
c) communicating the retrieved information to at least one of the electronic equipment and a display of the service apparatus.

11. The method of claim 10 wherein the communication is bi-directional.

12. The method of claim 10 wherein the communication between the electronic equipment and the service apparatus uses optical frequencies.

13. The method of claim 10 further comprising establishing a wireless communication link between the electronic equipment and the service apparatus.

14. The method of claim 10 wherein step b) further comprises restricting information retrieval in accordance with a user authorization indicated by a user key.

15. The method of claim 10 wherein the database is local to the service apparatus.

16. The method of claim 10 wherein the database is not local to the service apparatus.

17. The method of claim 10 wherein c) further comprises communicating at least a portion of the retrieved information to the electronic equipment, wherein the retrieved information includes at least one of the following types of information: configuration parameters, and firmware.

18. A method of servicing electronic equipment, comprising:
a) flashing a visual indicator of the electronic equipment using a first flash sequence in response to a service code event of the electronic equipment;
b) wirelessly broadcasting the service code independently of the presence of any service apparatus; and
c) flashing the visual indicator using a second flash sequence in response to a received wireless communication from a service apparatus, wherein the first and second flash sequences are distinct.

19. A service apparatus for servicing electronic equipment, comprising:
a local nonvolatile memory, the memory storing a database containing at least one of the following types of information: service instructions, configuration parameters, and firmware for the electronic apparatus;
a display; and
a wireless communication port, wherein information associated with a received service code wirelessly broadcast from the electronic equipment is retrieved from the database, wherein the retrieved information is communicated to at least one of the display and the electronic equipment.

20. The apparatus of claim 19 wherein the wireless communication port communicates using optical frequencies
